(19) United States
(12) Patent Application Publication
(10) Pub. No.: US 2008/0077849 A1
(43) Pub. Date: Mar. 27, 2008

(54) MECHANISM FOR ASSOCIATING ANNOTATIONS WITH MODEL ITEMS

(76) Inventors: Gregory D. Adams, Dunrobin (CA); P. Randolph Giffen, Kemptville (CA); Adam D. Wilson, Ottawa (CA); Grace P. Wong, North York (CA)

Correspondence Address: MARCIA L. DOUBET LAW FIRM, PO BOX 422859, KISSIMMEE, FL, 34742, US

(21) Appl. No.: 11/535,721

(22) Filed: Sep. 27, 2006

(51) Int. Cl. G06F 17/28; G06F 17/00

(52) U.S. Cl. 715/230

(57) ABSTRACT

A method, system and computer program product for maintaining an association between a marker and a model item in a data model is provided. A data model is loaded into a workspace. The data model is associated with the marker. The marker identifies the model item in the data model and thereby defines the association between the marker and the model item. The method obtains the association and responsive to a change in the data model that disrupts the association, updates the association to be valid, causing the marker to be updated accordingly if the changed data model is saved.

### BACKGROUND OF THE INVENTION

The present invention relates to the field of model-driven software development and more particularly to a method and apparatus for annotating model items in a data model.

Data structures used by computer programs can be represented using a data model. Software applications have been developed using a model-driven development approach by using these data models as blueprints to develop the program code.

A data model, used to represent a data structure, is typically described by a metamodel. Often these metamodels are visually represented using a graphical modeling language, such as Unified Modeling Language (UML) or Ecore. For developing software applications using Object Oriented (O) based programming languages, the graphical metamodel is commonly a class diagram consisting of classes, their attributes, methods and associations to other classes, although other formats for metamodels are also used.

Once a format for the data model has been described with a metamodel, a specific instance of a data model can be created by providing actual instances of the data objects and using actual values in place of the attributes. A typical data model consists of a number of different kinds of items with associations between the different items. These items are typically data objects and the attributes associated with the data objects.

Software programs have been designed to create and edit these data models by allowing items in the data model and associations between items to be created, modified and removed. The data model itself is a data structure defined as part of the software.

In many cases these data models, once created, can be used to generate program code that implements the created data model. A user can create a data model representing a yet unimplemented data structure using these software programs and then have program code generated that implements the data structure. In some cases, a program may interpret the data model directly, rather than using the data model to generate code.

Not only do these programs allow the creation of data models and in many cases the generation of program code from the created data model, they also commonly allow the data model to be edited or changed. A user, or many different users, may refine the data model during its development: adding more data objects; changing or adding attributes to an existing object; or editing the data model in other ways. Sometimes program code generated from a data model is found to be incorrect during debugging and the data model used to generate portions of the program code must be edited and changed to correct the final program code. It is very common for a data model to be significantly edited and changed between its original form, when it is first created, and its final finished form. It is also common for a data model once created to be saved and used over and over again to create program code for many different applications.

One example of a software program that has been designed to allow the creation and editing of data models, as well as the creation of program code from the data model is the Eclipse Modeling Framework (EMF). EMF is a modeling framework and code generation tool based on structured data models. From a data model described in XMI or other format such as an XML schema, EMF contains tools to enable viewing and editing of the data model.

Because of the ability of programs to modify and change a data model after the data model has been created, many programs require a way to “mark up” a data model with annotations, without modifying the data model itself. That is, they need a way to associate comments, error messages, highlight indicators, and other notes with the data model. For example, Eclipse provides marker support by allowing the annotation of files. EMF provides the ability to create markers which contain an attribute referencing a particular model item.

In many cases it is not enough to simply provide an annotation associated with a data file generally, there is often a need for increased granularity in the marker reference. For data models it is useful to associate a marker with an individual model item; a model object or a model feature. This is especially true of more complex data models containing numerous model items, making it hard to identify which specific model item an annotation may be related to. This requires a technique to identify individual model items in the data model and a way to establish an association between a marker or annotation and the model item.

While comments and other information can be inserted directly in the data model as attributes or other elements to annotate specific model items, this does not result in efficient code because these additions to the data model are only for the purpose of annotating the data model and are an unnecessary addition to the final code.

A typical approach to identifying specific model items in a data model is to assign each a unique id. This unique id can be: made an attribute of the model item; composed of several attributes of the item; or, it can be generated as required based on the location of the model item in an enumeration of the data model. Another approach is to use a “path” to locate the model item. The path starts with a known object in the data model and traverses associations between model items until the target model item is located.

This association between a marker and a model item, wherein the marker contains an attribute referencing the model item, works sufficiently well when the data model remains static (i.e. is not modified) or modification of the model does not alter the correct value of the attribute. For example, when the data model is persisted (i.e. serialized and stored to disk), the data model is typically not edited at this time and the use of a reference to a model item in a marker is sufficient to identify the association. However, if the data model is modified or changed, the model item being referenced by a marker may be modified or changed. When the data model is edited, model items may be removed or altered and the reference contained in the marker, that is used to indicate the associated model item, may cease to correctly indicate the desired model item, with the result that the association between the marker and the model item is broken, lost or incorrect. When the data model is edited, associating a marker and a model item by merely referencing the model item in an attribute of the marker, may not be sufficient and may cause the association to be broken or lost, with the result that the marker no longer correctly indicates the model item with which it is supposed to be associated.

### BRIEF SUMMARY OF THE INVENTION

It is an object of the present invention to provide a method and apparatuses that can maintain an association between an annotation and a specific model item in a data model even though the data model may be altered.

In one aspect, the present invention is directed to a method of maintaining an association between a marker and a model item in a data model. The method comprises loading the data model into a workspace, the data model having the marker associated therewith, the marker identifying the model item in the data model, thereby defining the association between the marker and the model item; obtaining the association; and,

responsive to a change in the data model that disrupts the association, updating the association to be valid and causing the marker to be updated accordingly if the changed data model is saved.

In one embodiment, the association is obtained by adding an adapter to the model item, the adapter being operative to hold a list of markers associated with the model item. The association may be identified in a mapping table. A listener may be added to the workspace wherein, in response to the listener determining that a new marker has been added that identifies a second model item in the data model thereby defining an additional association between the new marker and the second model item, the additional association is obtained. In response to the listener determining that the marker has been modified and identifies a second model item thereby defining a new association between the marker and the second model item, the association is removed and the new association obtained. In response to the listener determining the marker has been removed, the association is removed. The data model is saved by serializing it in a file.

### BRIEF DESCRIPTION OF THE SEVERAL VIEWS OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a pictorial representation of a data processing system in which aspects of the present invention may be implemented in accordance with an illustrative embodiment of the present invention;

FIG. 2 is a block diagram of a data processing system that may be implemented as a server in which aspects of the present invention may be implemented in accordance with an illustrative embodiment of the present invention;

FIG. 3 is an illustration of an exemplary metamodel used to define a data model;

FIG. 4 is a representation of a marker class, in accordance with aspects of the present invention;

FIG. 5 is a flowchart illustrating a method of referencing an associated model item with a newly created marker, in accordance with aspects of the present invention;

FIG. 6 is a flowchart illustrating a method of associating model items, in a loaded data model, with a marker, in accordance with aspects of the present invention;

FIG. 7 is a state diagram showing the data model being updated in response to an addition, modification or deletion of a marker, in accordance with aspects of the present invention; and

FIG. 8 is a flowchart illustrating a method of updating a set of makers before saving a data model to file, in accordance with aspects of the present invention.

### DETAILED DESCRIPTION OF THE INVENTION

Methods, computer program products and systems for associating an annotation (marker) with a particular object or attribute in a data model are provided. The methods are independent of any particular model involved. A marker created to describe a specific object or attribute in the data model contains an attribute identifying the object or attribute. When the data model is loaded by a client program, such as for editing, all of the markers for the data model are gathered and any markers containing an attribute identifying a specific object or attribute in the data model are associated directly with the specific object or attribute in the data model. In this manner, an association is created between a marker and a specific item in the data model. If the data model is modified or altered, a model item may be changed such that the marker attribute no longer indicates the model item, however, within the editor the marker will still be associated with the model item. When the data model is saved, the markers are updated to identify the proper model item, so that the markers show the proper associations when the data model is saved.

Data Processing System

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

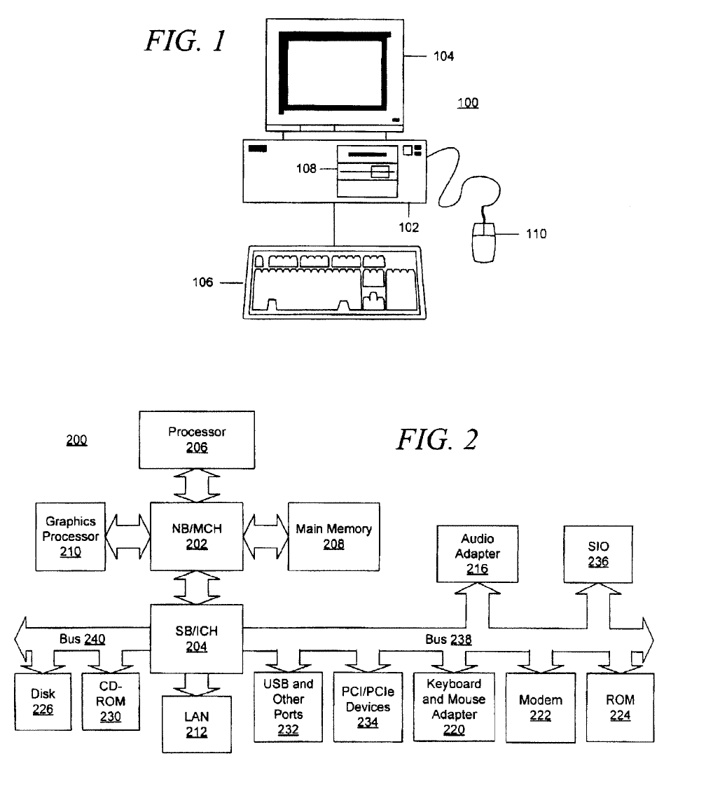

With reference now to the figures and in particular with reference to FIG. 1, there is shown a pictorial representation of a data processing system in which the aspects of the present invention may be implemented. A computer 100 is depicted which includes system unit 102, video display terminal 104, keyboard 106, storage devices 108, which may include floppy drives and other types of permanent and removable storage media, and mouse 110. Additional input devices may be included with computer 100, such as, for example, a joystick, touchpad, touch screen, trackball, microphone, and the like. Computer 100 can be implemented using any suitable computer, such as an IBM® eServer™ computer or IntelliStation® computer, which are products of International Business Machines Corporation, located in Armonk, N.Y. Although the depicted representation shows a personal computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which aspects of the present invention may be implemented. Data processing system 200 is an example of a computer or other data processing system, such as computer 100 in FIG. 1, in which code or instructions implementing the processes of the present invention may be located. In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 are coupled to south bridge and I/O controller hub 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204 through bus 238.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of one embodiment of the present invention, when such embodiment is implemented on a data processing system having the architecture of exemplary data processing system 200, are performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Exemplary Metamodel

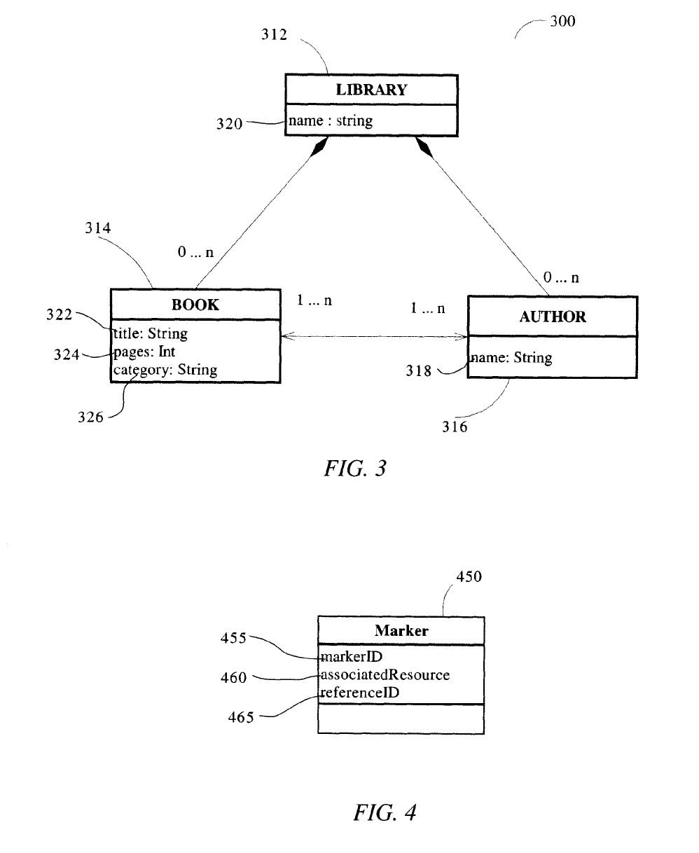

FIG. 3 is an exemplary illustration of a metamodel 300. The metamodel 300 describes a simple data structure using UML (unified modeling language) notation and is made up of a number of object types including: a library object type 312, used to describe a first library class; a book object type 314, used to describe a book class; and an author object type 316, used to describe an author class.

Each of these object types also specify attributes associated with the specific object type. For example, the library object type 312 contains a name attribute 320 that defines the library object type 312 holding a data string containing the name of the library. The book object type 314 contains: a title attribute 322, which holds a data string containing the title of the book; a pages attribute 324, containing the number of pages in the book; and a category attribute 326, containing a string identifying what category the book is in. Analogously, the author object type 316 contains a name attribute 318.

Using a metamodel describing the type of data that can be used, such as the metamodel 300 illustrated in FIG. 3, a data model can then be created providing an instance of data in accordance with the described metamodel. For example, using the metamodel 300 shown in FIG. 3, a data model can be constructed by providing a specific library name and then entering the books and authors contained in the library. Rather than having a single object representing all of the books, numerous data objects of the book object type 314 are created; one data object of the book object type 314 for each book contained in the library with the title of the book saved as the title attribute 322, the number of pages saved as the pages attribute 324 and the category attribute 326 holding a data string identifying the category the books belong to. The same will be true for the authors, with one data object of the author object type 316, for each author who has work in the library. As can be imagined, even for a relatively small library, an instance of a data model in accordance with metamodel 300 will contain numerous book and author data objects, each data object representing either a book or an author and each of the data objects containing a number of associated values as attributes of the data object.

Along with a data model, annotations are commonly used to tag the data models to communicate a problem with the model or other information to a user. Eclipse-based applications call these annotations “markers”. Typically, the marker is analogous to a yellow sticky note for the data model. The marker can be used to record any information regarding the data model.

A person skilled in the art will appreciated that a metamodel can take various forms. The exemplary metamodel 300, illustrated in FIG. 3, is in UML notation. A person skilled in the art will appreciate that metamodel formats such as Ecore, XML schemas, annotated Java interfaces, etc. could all be used to create a metamodel and that an instance of the metamodel (a data model) could take various forms, in accordance with aspects of the present invention.

In one embodiment of an aspect of the present invention, the disclosed methods are implemented for use with the Eclipse platform to extend its annotation mechanism for allowing annotations of files wherein the annotations are directly associated with a model item in the data model. This embodiment can be implemented as an Eclipse plug-in that defines a new marker type with an additional attribute that holds a reference to an EMF object within a data model. All markers created in accordance with the method will be subtypes of this new marker type.

In addition to specifying a new marker type, the plug-in also includes a utility class, MarkerManager, which implements the methods in accordance with aspects of the present invention. The MarkerManager provides a simple application programming interface (API) that allows various components of software applications to create new markers and use them.

Associating a Marker with a Model Item

Typically, annotations or markers are associated with the resource or data model, itself, and do not identify any specific model item (either a model object, attribute or structural element) in the data model. Calling a list of markers associated with a resource or data model returns all of the markers associated with that data model, however, the markers typically do not identify any specific model item in the data model to which the marker relates.

FIG. 4 illustrates a new marker type in accordance with aspects of the present invention. The marker 450 includes the following attributes: a markerID 455; an associated resource reference 460; and a referenceID 465.

The markerID 455 is a unique identifier assigned to each marker in order to identify a specific marker. In Eclipse this markerID is part of the standard marker class.

The associated resource reference 460 is used to identify the resource, i.e. the data model, that the marker is associated with and again in Eclipse this attribute is part of the standard marker class.

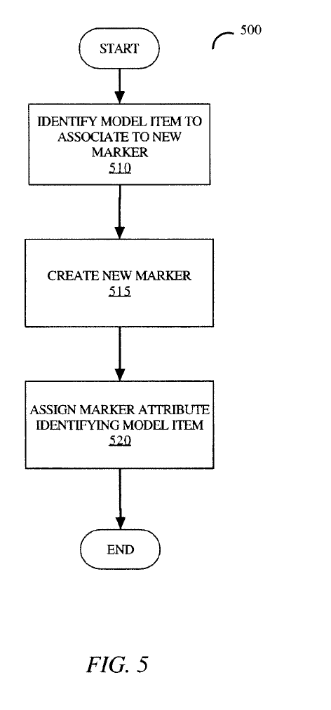

The referenceID 465 is a unique identifier associating the marker 450 with a specific item in the data model and is set by method 500, illustrated by the flowchart in FIG. 5. This unique identifier can be: an attribute of the model item; composed of several attributes of the item; generated as required based on the location of the model item in an enumeration of the data model; or, be based on a “path” that can be used to locate the model item, by starting with a known model item and traversing associations until the target model item is located.

FIG. 5 is a flow chart illustrating a method of creating a marker of a marker type shown in FIG. 4 that is associated with a specific model item in the data model, in accordance with aspects of the present invention. An association between the marker and a specific model item in a data model is created by adding a reference attribute to a marker type. The reference attribute is used to identify a specific model item in the data model.

The method 500 begins at step 510 with the method 500 determining a model item in a data model that should be associated with the marker that will be created. The model item can be a data object or structural element in the data model.

The method 500 creates a marker, of the type illustrated in FIG. 4, at step 515. The marker contains an attribute that holds a referenceID. The referenceID will be used to hold a value identifying the model item selected at step 510. Typically, whatever additional information that will be contained in the maker is also added at this time.

The method 500 then sets the referenceID of the marker at step 520. The referenceID is set to identify the model item, selected at step 510, as an attribute of the new marker. By default the referenceID can be based on a path of the model item in the data model. In the embodiment implemented using the utility class MarkerManager step 520 can be implemented by using an Application Programming Interface (API) that sets the value of the referenceID when the created marker and the selected model item are passed as input to a method in the MarkerManager.

In one embodiment adapted for the EMF framework, if the model item is a data object in the data model, a unique identifier of the model item could be obtained by having the MarkerManager include the following method:
public static void setEMFAttribute (IMarker marker, EOBject object) throws CoreException

This method can obtain the referenceID using the EMF framework by calling the method:
object.eResource( ).getURIFragment(object)

If the model item to be associated with the marker is an attribute or structural feature of a model object, for the EMF framework, the marker attribute referenceID can be set to reference the structural feature by passing the feature to the method as follows:
public static void setEMFAttribute(IMarker marker, EOBject object, EStructuralFeature feature) throws CoreException

This method can obtain the referenceID using the EMF framework by calling the method:
object.eResource( ).getURIFragment (object)+“//” feature.getName( ) (for a feature of an EObject)

Once the method 500 has completed step 520 and the referenceID in the marker is set to identify the associated model item, the method 500 is complete.

If a programming language such as Java is used to implement the method 500, in some cases, it may be desirable to implement the method as a static method so that an instance of MarkerManager is not required to set the attribute, referenceID, of a marker.

By using method 500, an association between a marker and a specific model item in a data model is defined by referencing the model item (either a model object or a structural feature of a model object) as an attribute of the marker. The association between a marker and a specific model item can be identified by looking at the referenceID attribute in the marker to determine the model item indicated by the referenceID. This association indicated by a single reference contained in the marker alone, may be sufficient for data models that are typically always static, i.e. the data model is not modified. For example a data model that has been created, serialized and saved as a file is typically not modified while saved in a file format. However, this association may be lost if the data model is modified in such a way that the model item referenced by a marker is altered with the result that the referenceID contained in the marker no longer indicates the model item. At this point, if the model item referenced by a marker is modified or removed, the reference used to indicate the model item may be altered and the referenceID stored in the marker may cease to indicate the desired (or any) model item. The additional attribute added to the marker, alone, is unable to maintain associations between the marker and the model item, if the model item is edited to the point where the referenceID is no longer correct.

By using method 500 any number of markers associated with a data model can be created that reference a number of different model items in the data model.

Obtain Markers for a Data Model

At this point the created marker is not only associated with the resource (i.e. data model) itself, but more specifically it is associated with a specific model item in the data model by referencing the model item as an attribute of the marker. Each marker associated with a data model and containing a referenceID attribute is associated also with a specific model item through the use of the referenceID. This means that the marker has access to information identifying the associated model item, however, at this point the associated model item does not have access to this information. The model item can not determine which markers are associated with it.

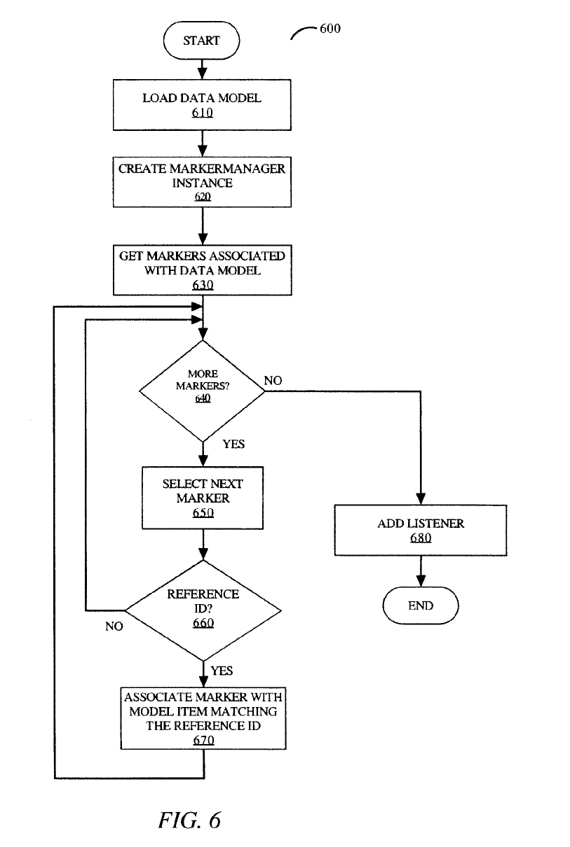

FIG. 6 is a flowchart illustrating a method 600 of maintaining associations between markers and their associated model items, even though the data model may be altered. When a program, such as an editing program, wants to access a saved data model, the data model will be loaded by the program. Along with this saved data model, any markers associated with the data model are also obtained by the program. These markers will initially only be associated with the file containing the data model itself.

In addition to identifying an association between a marker and a specific model item in the data model, by having the markers contain an attribute identifying the association, method 600 uses these markers, with their attributes referencing specific model items, to obtain a direct association between the model items and their associated markers, for example within the memory of a data processing system implementing a method according to an aspect of the present invention. If a model item in the data model is then modified or changed to the extent that the referenceID in a marker no longer references the model item correctly, the model item is still associated with the marker (for example the memory) and the data processing system can then update the referenceID of the marker, to correctly identify the model item, before the data model is saved to file.

The method 600 begins with a data model being loaded from file at step 610 by a client program, for example an editor. An instance of MarkerManager is created at step 620 and the data model and file containing the data model is passed to the MarkerManager instance to associate the model items with the markers.

The method 600 obtains all of the markers associated with the data model at step 630. If Eclipse is used as the software platform, a standard Application Programming Interface (API) provided by Eclipse, that allows all of the markers or annotations associated with a data model to be collected, can be used to implement step 630. For example, Eclipse has a standard API that can be used to call a standardized method that returns all of the markers associated with a data model (i.e. a resource).

Once the method 600 has obtained all of the markers associated with a data model at step 630, the method 600 checks, at step 640, if any markers have been returned. If no markers have been returned a listener is added to the workspace at step 680 and method 600 ends.

However, if one or more markers have been returned at step 630, a first marker is selected at step 650 and the selected marker is analyzed, at step 660, to determine if it contains a referenceID that indicates an association to a specific model item in the data model. If at step 660, the selected marker does not contain a referenceId, indicating an association with a specific model item in the data model, the marker is treated as a standard marker and the method 600 checks for more markers at step 640 and selects the next marker at step 650, if there are more markers. The selected marker is then analyzed at step 660.

If at step 660, the marker contains a referenceID, indicating an association to one of the model items, the method 600 determines the specific model item in the data model indicated by the referenceID and obtains a direct association from the marker to its corresponding model item and to the marker from the model item at step 670.

In an embodiment implemented for EMF, step 670 can be implemented by using EMF's adapter mechanism to obtain the association between the identified model item and the marker. An adapter is added to the adapter list of the EMF object corresponding to the indicated model item, this adapter is used to hold a list of all the markers associated with the model item. In addition, a mapping table can be used to hold the marker to model item associations and by adding the marker object and the model item to the mapping table to identify the association.

In this manner, not only has an association been created between the marker and the model item, with the marker referencing the model item directly using an entry in a mapping table, but now the model item is associated directly with the marker. Rather than only the marker being aware of the association with the model item, the model item is now aware of the association of the marker, as well. By obtaining the association between the model item with the marker using the adapter mechanism, the association only persists while the data model is opened. Once it is saved to file (i.e. serialization) the adapter mechanism will not leave any trace of this association between the model item and the marker in the data model and there will be no trace of this association in the actual data generated as program code. Other techniques, in addition to the EMF adaptor mechanism, may be used to create the desired association between a marker and the corresponding model item.

After obtaining the association between the marker and the indicated model item at step 670, the method 600 then checks, at step 640, to see if there are any more markers, which were returned at step 630, but have not been analyzed. If there are more markers remaining to be analyzed, the method 600 selects the next marker at step 650 and repeats steps 660, 670, 640 and 650, obtaining an association between each marker, if the marker contains a referenceID, and a model item indicated by the referenceID, until no more markers remain. At this point, an association has been obtained for all of the markers referencing a specific model item in the data model using a referenceID.

Once there are no more makers remaining at step 640, the method 600 adds a general listener to the workspace at step 680 and then the method 600 ends. This listener continues to listen for changes in the data model and will notify the MarkerManager should a marker be added, modified or removed.

If EMF is being used, the listener added in step 680 can use the standard EMF notification mechanism to inform clients listening for changes to a data model of changes to the markers associated with an item. The MarkerManager can use this mechanism to issue a notification when a marker associated with an EMF object is added, removed, or changed. Other listeners and notification mechanisms may also be used.

After the listener has been added to the workspace at step 680, the method 600 ends.

Using method 600, not only do the markers reference the model item, but each model item will contain a list of all the markers associated with that model item, while the data model is being accessed by a client program. The data model can be modified and the associations between model items and markers are preserved. When a data model is modified, the identifier or path of an object representing a model item in the data model may change, causing a referenceID of an associated marker to no longer indicate the associated model item, however, since the markers are now associated with their respective model item(s) via a mapping table and an adapter, the association may be maintained even in the absence of an accurate referenceID in the marker.

Updating the Model Item Association in Response to the Addition, Modification or Removal of a Marker

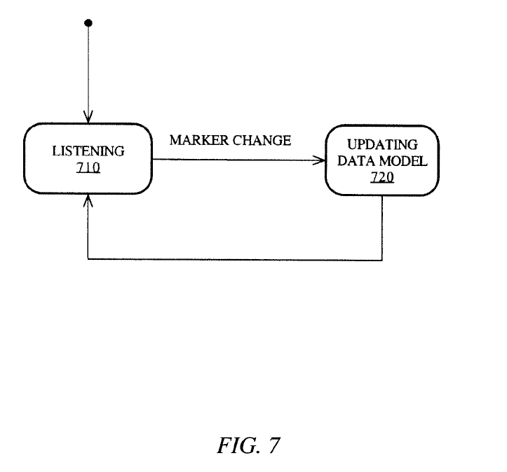

FIG. 7 is a state diagram illustrating the updating of a model item in response to the listener learning that a marker has been added, modified or removed. The listener, added to the workspace at step 680 of the method 600 illustrated in FIG. 6, is notified if any markers are added, modified or removed. If this occurs the MarkerManager will use the new or altered marker, locate the model item that the marker is associated with and associate the model item with the marker.

After the listener is added, the listener begins in a listening state 710, listening for any changes to the workspace. In response to a marker change (a marker has been added, modified or removed) the data model is updated 720. For an implementation in EMF using a MarkerManager utility class to implement the methods, a method in MarkerManager can be called to update the model item affected by the marker modification. Again, in the first embodiment implemented for EMF, an entry is added to a mapping table and an adapter is used to add the marker to a list contained in the model object.

If a marker has been added, the method associates the new marker with the model item indicated in the referenceID attribute of the marker and notifies the model item listeners that the item has changed. If the marker has been modified, listeners are notified that the model item has changed. If a marker has been removed then the association between the marker and the model item is removed.

Once the data model and model items affected have been updated, the listening state 710 is resumed.

Saving the Data Model and Updating the Markers

When the client program is finished using the data model (i.e. a user is done editing a data model using an editor program) and wishes to save the data model to file, a method is carried out to update the markers so that the markers are in sync with the data model before the data model is saved, and indicate the proper model items.

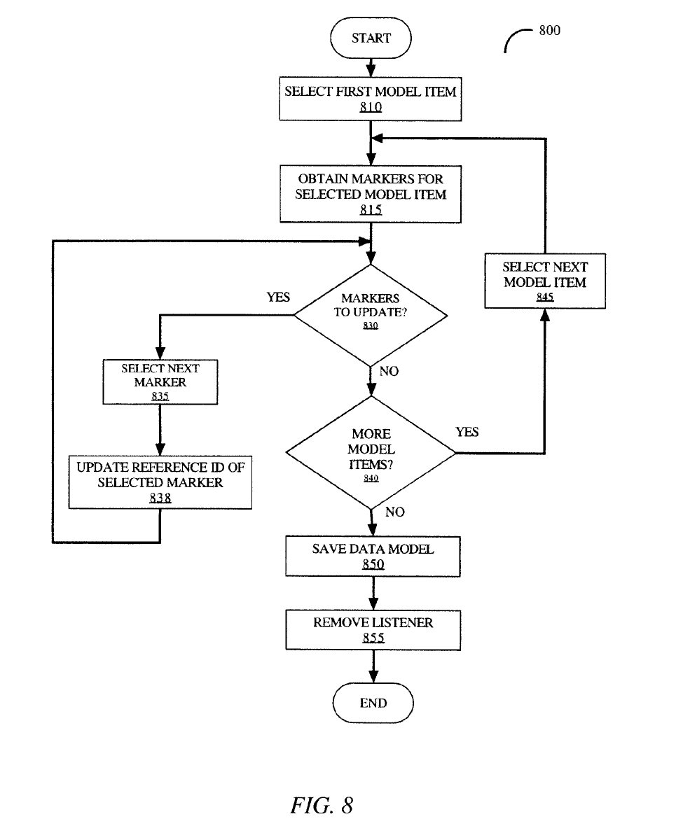

FIG. 8 illustrates a flowchart of a method 800 carried out to update the referenceID of the markers to indicate the proper model items, if the model items have been modified. In this manner, the markers properly reference their associated model items when the data model is saved to storage and therefore when the data model is retrieved from storage.

Method 800 begins and a first model item is selected for updating at step 810.

Next, the method 800 obtains any markers associated with the selected model item at step 815. If the method is being implemented for EMF with a MarkerManager utility class implementing the methods, the markers associated with a model item can be obtained by calling the following method:

public static List getMarkers(EObject)

to obtain all of the makers associated with a given model item;

public static List getMarkers(Eobject object, Boolean includeChildren)

to obtain all of the markers associated with a given model item and all of its child model items; and

public static List getMarkers(EObject object, EstructuralFeature feature)

to obtain all of the markers associated with a given feature of a given model item.

If an implementation such as Java is used, it may be desirable to have these methods as static calls. The API can be static because it simply asks the EMF object for the adapter which contains the list of associated markers and returns the appropriate markers.

At step 830, the method 800 checks to see if any markers have to be updated for the selected model item. If there are no markers to update, the method 800 proceeds to step 840. However, if there are markers, associated with the selected model item, that have been returned, the method 800 selects a first marker at step 835 and updates the referenceID of the first marker at step 838. Method 800 then moves to step 830 and the method 800 checks for more markers. The method 800 repeats steps 830, 835, 838 and 830 again until all the markers associated with a model item have been checked and updated.

Once all the markers have been updated for a selected model item, the method 800 checks to see if any more model items remain to have their associated markers updated at step 840. The model items selected may be: all the model items in the data model, to ensure that all of the markers are in sync with the data model when the data model is saved; only model items that have been modified, created or deleted in the data model; or only the model items in the data model that have been modified, created or deleted in the data model which resulted in the referenceIDs contained in associated markers no longer properly indicating the correct model item.

The method 800 will continue to repeat steps 815, 830, 835, 838, 840 and 845 until all markers have been updated so that their referenceIDs indicate the proper model items in the data model. The model 800 then saves the data model at step 850. Typically, if the method was implemented for EMF the data model is saved by serializing and saving it in storage.

Finally, the listener added to the workspace is stopped at step 855, so that it no longer listens for marker changes, and the method 800 ends. Typically, in the first embodiment a method such as disposes in MarkerManager is called to stop the listener.

In this manner when the data model is saved (in the case of the EMF, the data model is by default serialized using the XMI format) all associations with the markers are removed from the data model and the markers have been updated so that the markers are always kept in sync with the data model that is saved to disk.

The foregoing is considered as illustrative only of the principles of the invention. Further, since numerous changes and modifications will readily occur to those skilled in the art, now informed by the herein disclosure, it is not desired to limit the invention to the exact construction and operation shown and described, and accordingly, all such suitable changes or modifications in structure or operation which may be resorted to are intended to fall within the scope of the claimed invention.

What is claimed is:

1. A method of maintaining an association between a marker and a model item in a data model, the method comprising:
loading the data model into a workspace, the data model having the marker associated therewith, the marker identifying the model item in the data model, thereby defining the association between the marker and the model item;
obtaining the association; and
responsive to a change in the data model that disrupts the association, updating the association to be valid and causing the marker to be updated accordingly if the changed data model is saved.

2. The method of claim 1 wherein the association is obtained by adding an adapter to the model item, the adapter operative to hold a list of markers associated with the model item.

3. The method of claim 2 wherein the association is identified in a mapping table.

4. The method of claim 3 wherein a listener is added to the workspace and in response to the listener determining that a new marker has been added that identifies a second model item in the data model thereby defining an additional association between the new marker and the second model item, obtaining the additional association.

5. The method of claim 4 wherein in response to the listener determining that the marker has been modified and identifies a second model item thereby defining a new association between the marker and the second model item, removing the association and obtaining the new association.

6. The method of claim 5 wherein in response to the listener determining the marker has been removed, removing the association.

7. The method of claim 1 wherein the data model is saved by serializing it in a file.

8. A data processing system for maintaining an association between a marker and a model item in a data model, the data processing system comprising:
at least one processor;
at least one memory operatively coupled to the at least one processor; and
a program module stored in the at least one memory and operative for providing instructions to the at least one processor, the at least one processor responsive to the instructions of the program module, the program module operative for:
loading the data model into a workspace, the marker identifying the model item in the data model, thereby defining the association between the marker and the model item;
obtaining the association; and
responsive to a change in the data model that disrupts the association, updating the association to be valid and causing the marker to be updated accordingly if the changed data model is saved.

9. The data processing system of claim 8 wherein the association is obtained by adding an adapter to the model item, the adapter operative to hold a list of markers associated with the model item.

10. The data processing system of claim 9 wherein the association is identified in a mapping table.

11. The data processing system of claim 10 wherein the at least one processor is operative for adding a listener to the workspace and in response to the listener determining that a new marker has been added that identifies a second model item in the data model thereby defining an additional association between the new marker and the second model item, obtaining the additional association.

12. The data processing system of claim 11 wherein the at least one processor is operative for, in response to the listener determining that the marker has been modified and identifies a second model item thereby defining a new association between the marker and the second model item, removing the association and obtaining the new association.

13. The data processing system of claim 12 wherein the at least one processor is operative for, in response to the listener determining that the marker has been removed, removing the association.

14. The data processing system of claim 8 wherein the data model is saved by serializing it in a file.

15. A computer program product comprising at least one computer useable medium including a computer readable program for maintaining an association between a marker and a model item in a data model, wherein the computer readable program comprises:
computer-usable program code for loading a data model into a workspace, the data model having the marker associated therewith, the marker identifying the model item in the data model, thereby defining the association between the maker and the model item;
computer-usable program code for obtaining the association; and
computer-usable program code for, responsive to a change in the data model that disrupts the association, updating the association to be valid and causing the markers to be updated accordingly if the changed data model is saved.

16. The computer program product of claim 15, further comprising computer-usable program code for obtaining the association by adding an adapter to the model item, the adapter operative to hold a list of markers associated with the model item.

17. The computer program product of claim 16 wherein the association is identified in a mapping table.

18. The computer program product of claim 17 further comprising computer-usable program code for adding a listener to the workspace and in response to the listener determining that a new marker has been added that identifies a second model item in the data model thereby defining an additional association between the new marker and the second model item, obtaining the additional association.

19. The computer program product of claim 18 further comprising computer-usable program code for, in response to the listener determining that the marker has been modified and identifies a second model item thereby defining a new association between the marker and the second model item, removing the association and obtaining the new association.

20. The computer program product of claim 19 further comprising computer-usable program code for, in response to the listener determining that the marker has been removed, removing the association.
